(19) United States
(12) Patent Application Publication
(10) Pub. No.: US 2012/0097596 A1
(43) Pub. Date: Apr. 26, 2012

(54) FILTERING SYSTEM

(75) Inventor: Kwang-Jin Lee, Gyeonggi-do (KR)

(73) Assignee: KOLON INDUSTRIES, INC., Kwacheon-si, Kyunggi-do (KR)

(21) Appl. No.: 13/258,964

(22) PCT Filed: Mar. 23, 2010
(86) PCT No.: PCT/KR2010/001773

§ 371 Date: Dec. 2, 2011

(30) Foreign Application Priority Data
Mar. 23, 2009 (KR) 10-2009-0024447

(51) Int. Cl. B01D 65/08; B01D 63/08; B01D 63/04

(52) U.S. Cl. 210/321.69

(57) ABSTRACT

Disclosed is a filtering system which facilitates to maximize cleaning efficiency as contrasted with energy consumed for aeration cleaning of a filtering membrane module, and minimize horizontal dependence of an aeration tube, the filtering system comprising first and second aeration tube positioned under a plurality of filtering membrane modules, wherein a distance between the first and second aeration tubes and a diameter of the aeration hole are limited to a predetermined range.

### TECHNICAL FIELD

The present invention relates to a filtering system, and more particularly to a filtering system which facilitates to maximize cleaning efficiency as contrasted with energy consumed for aeration cleaning of a filtering membrane module, and minimize horizontal dependence of an aeration tube.

### BACKGROUND ART

A separation method using a membrane has lots of advantages over the method based on heating or phase-changing. Among the advantages is high reliability of water treatment since the water purity required can be easily and stably satisfied by adjusting the size of the pores of a membrane. Furthermore, since the separation method using a membrane does not require a heating process, a membrane can be used with microorganism which is useful for separation process but may be adversely affected by heat.

One kind of the hollow fiber membrane modules is a suction type hollow fiber membrane module (or may also be referred to as an internal pressure type hollow fiber membrane module) which is submerged into a water tank filled with fluid to be treated. Negative pressure is applied to the inside of the hollow fiber membranes, whereby only fluid passes through the wall of each membrane and solid elements such as impurities and sludge are rejected. This suction type hollow fiber membrane module is advantageous in that the manufacturing cost is relatively low and that the installation and maintenance cost is reduced since a facility for circulating fluid is not required. However, the suction type hollow fiber membrane module has a disadvantage of the limitation on flux per unit period.

In opposition to the suction type hollow fiber membrane module, there is an external pressure type hollow fiber membrane module. In case of the external pressure type hollow fiber membrane module, external pressure is applied to fluid to be treated. Even though the external pressure type hollow fiber membrane module necessarily requires a facility for circulating fluid, a flux per unit period in the external pressure type hollow fiber membrane module is relatively larger than a flux per unit period in the suction type hollow fiber membrane module.

When the fluid in which contaminants including solid elements are suspended is filtered through the use of filtering membrane module, the filtering membrane might be easily contaminated due to the contaminants, thereby causing low water permeability of the filtering membrane. Herein, since various types of contaminants make the filtering membrane contaminated in different ways, it is necessary to clean the filtering membrane in various methods. According to a cleaning purpose, a method for cleaning the contaminated filtering membrane may be largely classified into a maintenance cleaning and a recovery cleaning.

The recovery cleaning is performed when the filtering membrane module exhibits serious deterioration in permeation performance of a membrane due to contaminants accumulated by a long-term use in the water-treatment tank. A main purpose of the recovery cleaning is to recover permeation performance of the membrane.

A main purpose of the maintenance cleaning is to maintain good permeation performance of filtering membrane. The maintenance cleaning is mainly performed via physical cleaning such as backwashing process or aeration process during a water treatment or after a temporary stoppage of water treatment. The physical cleaning may be classified into a backwashing process and an aeration process.

The backwashing process removes impurities from a surface of membrane by causing air or water to flow backward through the membrane during a temporary stoppage of water treatment. The aeration process removes impurities from a surface of membrane by generating rising air bubbles through air jetted from an aeration tube positioned under the membrane, and causing the rising and circulation of water filled in a water-treatment tank.

For the aeration process of the maintenance cleaning, a blower is typically used for jetting the air. In this case, since the blower has to be continuously driven for the aeration cleaning of the filtering operation, it inevitably causes large energy consumption. However, there has been no research about a method for maximizing aeration performance as contrasted with energy consumption, that is, a method for maximizing aeration efficiency.

In case of the aeration tube jetting the air for the aeration cleaning, an initial horizontal state of the aeration tube might be not maintained by reaction to the jetted air. When the aeration tube is not maintained in the horizontal state for the aeration cleaning, the air jetted from the aeration tube is concentratedly supplied toward a direction, whereby it is difficult to uniformly clean the entire filtering membrane. In order to overcome this problem, the aeration tube should be maintained perfectly in the horizontal state. However, due to vibration of the filtering system by the air jetted from the aeration tube, it is virtually impossible to maintain the aeration tube in the horizontal state. In this respect, there is a need to study a method for minimizing the concentrated supply of air jetted from the aeration tube even though the aeration tube is not maintained in the horizontal state somewhat, that is, a method for minimizing horizontal dependence of the aeration tube.

### DISCLOSURE

### Technical Problem

Therefore, the present invention is directed to a filtering system and method that substantially obviates one or more of the problems due to limitations and disadvantages of the related art.

An aspect of the present invention is to provide a filtering system which facilitates to obtain maximum cleaning efficiency as contrasted with energy consumed for aeration cleaning of a filtering membrane module.

Another aspect of the present invention is to provide a filtering system which facilitates to minimize horizontal dependence of an aeration tube.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, a filtering system comprises: a plurality of filtering membrane modules; a first aeration tube positioned under the plurality of filtering membrane modules; and a second aeration tube next to the first aeration tube, the second aeration tube being positioned under the plurality of filtering membrane modules, wherein the first aeration tube includes a plurality of first aeration holes which include a first reference aeration hole, wherein the first reference aeration hole is closest to the second aeration tube among the first aeration holes, wherein the second aeration tube includes a plurality of second aeration holes which include a second reference aeration hole, wherein the second reference aeration hole is closest to the first reference aeration hole among the second aeration holes, and wherein a distance between the first and second reference aeration holes is adjusted to satisfy the following equation 1,

0.9·2·(H+d)·tan(θ/2)≦D≦1.1·2·(H+d)·tan(θ/2) [Equation 1]

wherein ‘D’ is the distance (m) between the first and second reference aeration holes, ‘H’ is a height (m) of the filtering membrane module, ‘d’ is a distance (m) between the first reference aeration hole and the filtering membrane modules, and ‘θ’ is an aeration angle.

In another aspect of the present invention, there is provided a filtering system comprising: a filtering membrane module; and first and second aeration tubes next to each other and positioned under the filtering membrane module, wherein the first aeration tube includes a plurality of first aeration holes arranged in line along a longitudinal direction of the first aeration tube, wherein the plurality of first aeration holes include a first reference aeration hole which is closest to the second aeration tube among the first aeration holes, wherein the second aeration tube includes a plurality of second aeration holes arranged in line along a longitudinal direction of the second aeration tube, wherein the plurality of second aeration holes include a second reference aeration hole which is closest to the first reference aeration hole among the second aeration holes, and wherein a distance between the first aeration holes and a distance between the second aeration holes are identical with or smaller than a distance between the first and second reference aeration holes.

In another aspect of the present invention, there is provided a filtering system comprising: a filtering membrane module; and an aeration tube including a plurality of aeration holes, the aeration tube positioned under the filtering membrane module, wherein a diameter of the aeration hole is 5 mm to 7 mm.

It is to be understood that both the foregoing general description and the following detailed description are exemplary and explanatory and are intended to provide further explanation of the invention as claimed.

### Advantageous Effects

According to a filtering system of the present invention, the distance between the aeration tubes is optimized so that the cleaning efficiency can be maximized and at the same time the energy consumption for the cleaning can be minimized when the maintenance cleaning or aeration cleaning is performed.

Also, the horizontal dependence of the aeration tube is minimized, whereby it is possible to clean the filtering membrane entirely and uniformly.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates an exemplary filtering system according to one embodiment of the present invention.

FIGS. 2 and 3 illustrate exemplary arrangements of aeration holes in an aeration tube.

FIG. 4 illustrates a filtering system with an excessively-large distance between aeration tubes.

FIG. 5 illustrates a filtering system with an excessively-small distance between aeration tubes.

FIG. 6 illustrates a filtering system with an optimal distance between aeration tubes.

FIG. 7 is a graph showing the change of consumed energy (Inverter Frequency, Hz) according to the increase of air flux (L/min) jetted from an aeration hole.

FIG. 8 is a photograph image obtained by taking a photograph of the surface of water when air is jetted at an air flux of 400 L/min under the circumstances that aeration tubes having aeration hole whose diameter is 8 mm are provided at about 5° with respect to the bottom surface of water-treatment tank.

FIG. 9 is a photograph image obtained by taking a photograph of the surface of water when air is jetted at an air flux of 400 L/min under the circumstances that aeration tubes having aeration hole whose diameter is 5 mm are provided at about 5° with respect to the bottom surface of water-treatment tank.

### BEST MODE

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

Hereinafter, a filtering system according to the present invention will be described with the accompanying drawings.

For the following description of the present invention, a filtering membrane module is illustrated as a hollow fiber membrane module, but it is not limited to this type. For example, the present invention may be applied to various kinds of filtering membrane modules including a flat-type module as well as the hollow fiber membrane module.

The technical idea of the present invention can be identically applied to both a through-both-ends water collection type and a through-one-end water collection type, wherein the through-both-ends water collection type uses two headers so as to collect permeates from both ends of a hollow fiber membrane, and the through-one-end water collection type uses one header so as to collect permeates from one end of a hollow fiber membrane.

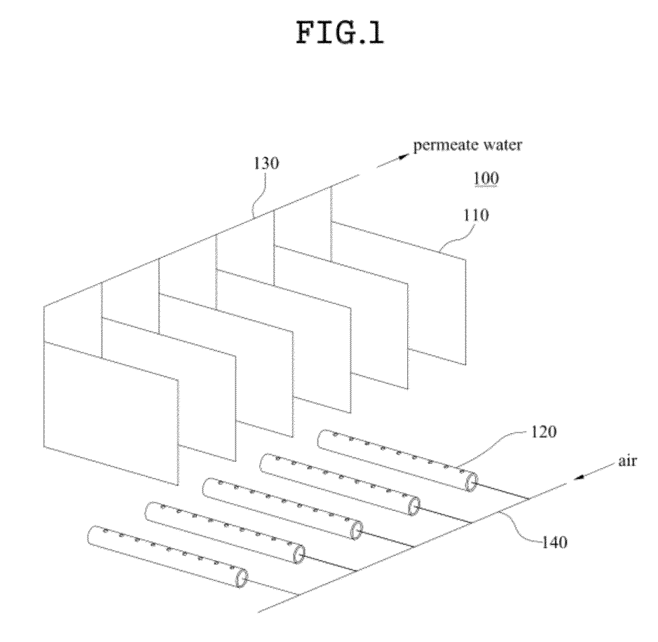

FIG. 1 illustrates an exemplary filtering system according to one embodiment of the present invention.

As shown in FIG. 1, the filtering system 100 according to the present invention includes a plurality of filtering membrane modules 110. Each filtering membrane module 110 may be a hollow fiber membrane module using a bundle of hollow fiber membranes as a filtering membrane, or may be a flat-type module using a flat-type membrane as a filtering membrane. Herein, the hollow fiber membrane module has a large surface area. In consideration for an occupying space, a water-treatment efficiency of the hollow fiber membrane module is relatively higher than a water-treatment efficiency of the flat-type module.

FIG. 1 illustrates a submerged-type filtering membrane module, wherein a filtering process is performed under the circumstances that a filtering membrane is submerged into a fluid to be treated in a water-treatment tank (not shown). In case of the submerged-type filtering membrane module, a negative pressure is applied to the inside of filtering membrane, whereby only fluid selectively permeates through the filtering membrane, thereby separating impurities or solid matters such as sludge from the fluid.

The filtering membrane module 110 according to one embodiment of the present invention may be the hollow fiber membrane module. More particularly, the filtering membrane module 110 according to one embodiment of the present invention may be a vertical type hollow fiber membrane module in which a longitudinal direction of the hollow fiber membrane is perpendicular to the bottom surface of the water-treatment tank, or a horizontal type hollow fiber membrane module in which a longitudinal direction of the hollow fiber membrane is parallel to the bottom surface of the water-treatment tank.

The filtering membrane module 110 according to the present invention may be provided with a plurality of modules combined with a frame (not shown). Permeate water obtained through the plurality of filtering membrane modules 110 is supplied to permeate-water storage tank (not shown) via a common pipe 130.

When sewage/waste water in which contaminants including solid elements are suspended is filtered through the use of filtering membrane module 110, the surface of filtering membrane is contaminated due to the contaminants, whereby water permeability might be largely lowered by the progress of water treatment. Thus, it is preferable to perform the maintenance cleaning of the aeration process for maintaining the good permeability of the filtering membrane for the water treatment by the filtering membrane module 110.

In order to perform the aeration process for preventing the surface of the filtering membrane from being contaminated, the filtering system 100 according to the present invention further includes a plurality of aeration tubes 120 positioned under the filtering membrane modules 110. The plurality of aeration tubes 120 may be arranged in parallel. The plurality of aeration tubes 120 are supplied with air from an air supplier (not shown), for example, a blower via a common pipe 140.

A plurality of aeration holes 121 are formed in the aeration tube 120. The air introduced to the aeration tube is upwardly jetted toward the filtering membrane modules 110 via the plurality of aeration holes 121.

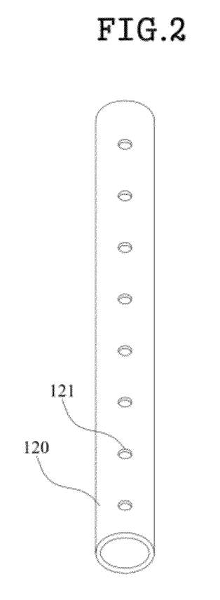

FIGS. 2 and 3 illustrate various arrangements of the aeration holes 121 in the aeration tube 120.

In case of the aeration tube 120 according to the first embodiment of the present invention, as shown in FIG. 2, the aeration holes 121 are arranged in line along the longitudinal direction of the aeration tube 120.

As shown in FIG. 3, the aeration tube 120 according to the second embodiment of present invention includes a plurality of pairs of aeration holes 122 arranged in line along the longitudinal direction of the aeration tube 120. Each pair of the aeration holes 122 comprise two aeration holes 122a, 122b, wherein the two aeration holes 122a, 122b are formed in line perpendicular to the longitudinal direction of the aeration tube 120. Thus, the aeration tube 120 according to the second embodiment of the present invention is capable of jetting more air toward the filtering membrane module 110, whereby it is more profitable to occurrence of a turbulent flow for preventing the contamination of filtering membrane.

The aeration tubes 120 of the filtering system 100 according to the present invention may be provided only with the aeration tubes 120 according to the first embodiment of the present invention; provided only with the aeration tubes 120 according to the second embodiment of the present invention; or provided with the alternately-arranged aeration tubes 120 according to the first and second embodiments of the present invention.

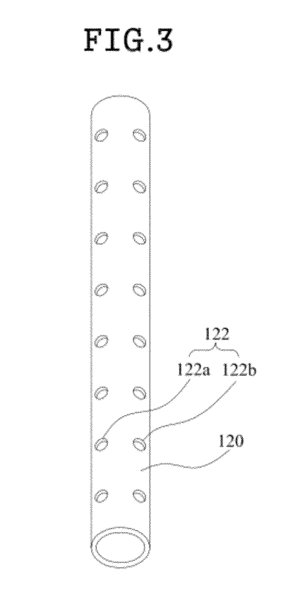

As mentioned above, in case of the maintenance cleaning of the aeration process, the air is continuously jetted through the aeration tubes 120 for the filtering process, thereby causing large energy consumption. Thus, there is a need to maximize aeration efficiency as contrasted with the energy consumption. Based on the researches by the present inventor, it is known that the aeration efficiency deeply relates with the distance between the aeration tubes 120, which will be explained with reference to FIGS. 4 to 6.

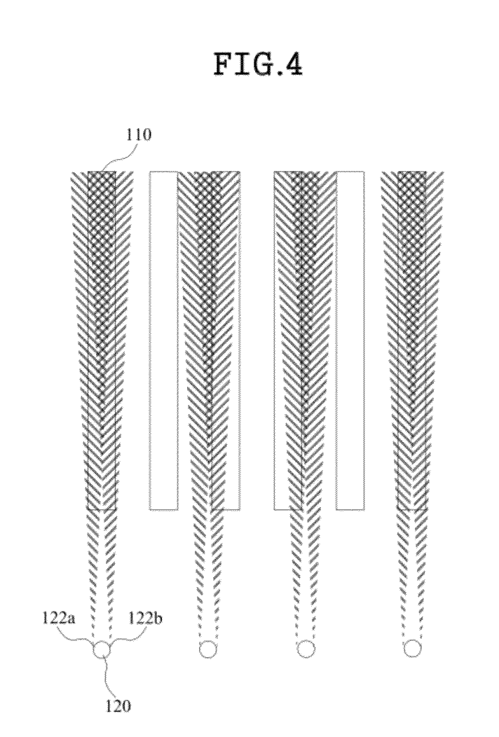

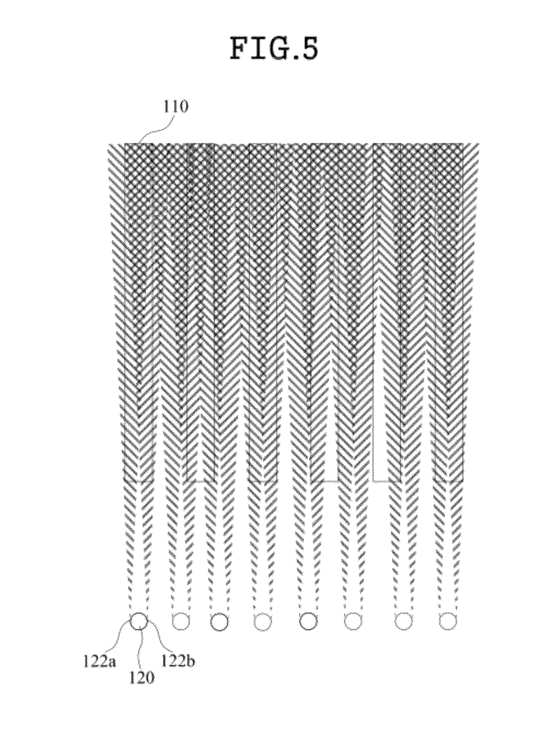

FIG. 4 illustrates the filtering system with the excessively-large distance between aeration tubes 120. FIG. 5 illustrates the filtering system with the excessively-small distance between aeration tubes 120. FIG. 6 illustrates the filtering system with the optimal distance between aeration tubes 120.

In the aeration tube 120 shown in FIGS. 4 to 6, a plurality of pairs of aeration holes 122 are arranged in line along the longitudinal direction of the aeration tube 120. The air jetted through the aeration holes 122a, 122b generates bubbles in the fluid to be treated, and the bubbles rise at a predetermined angle (hereinafter, referred to as ‘aeration angle’ toward the filtering membrane modules 110, thereby separating the contaminants from the surface of the filtering membrane.

As shown in FIG. 4, when the distance between the aeration tubes 120 is excessively large, and more particularly, the distance between the aeration holes 122a, 122b of the neighboring aeration tubes 120 next to each other is excessively large, the number of aeration tubes 120 is decreased so that it is somewhat profitable in aeration energy. However, the bubbles which are generated by the aeration tubes 120 and rise toward the filtering membrane modules 110 do not meet together until they attain the uppermost of the filtering membrane modules 110. As a result, there exists the filtering membrane which does not contact with the rising bubble. It means that some filtering membranes of the filtering system are vulnerable to contamination, which causes the rapid decrease of permeate flow rate by the process of water treatment.

As shown in FIG. 5, when the distance between the aeration tubes 120 is excessively small, and more particularly, a distance between the aeration holes 122a, 122b of the neighboring aeration tubes 120 next to each other is excessively small, the bubbles which are generated by the aeration tubes 120 and rise toward the filtering membrane modules 110 are overlapped before they attain the uppermost of the filtering membrane modules 110. Thus, all filtering membranes contact with the bubbles rising from the aeration tubes 120 so that is profitable in contaminating prevention of the filtering membrane. However, the bubbles being more than necessary pass through the space where the rising bubbles are overlapped before they attain the uppermost of the filtering membrane modules, thereby causing the waste of energy.

As shown in FIG. 6, in consideration for the aeration efficiency, it is the most preferable to meet the bubbles rising at a predetermined aeration and (θ) together when they attain the uppermost of the filtering membrane modules 110. Thus, according to the present invention which sets 10% permissible error, the distance between the aeration holes 122a, 122b of the neighboring aeration tubes 120 is adjusted as follows.

Among the aeration tubes 120 positioned under the filtering membrane modules 110, the two neighboring aeration tubes 120 are referred to as the first and second aeration tubes.

The plurality of first aeration holes 122 are formed in the first aeration tube 120, wherein the plurality of first aeration holes 122 include a first reference aeration hole (h1). The first reference aeration hole (h1) indicates the aeration hole which is closest to the second aeration tube 120 among the first aeration holes 122. Also, the plurality of second aeration holes 122 are formed in the second aeration tube 120, wherein the plurality of second aeration holes 122 include a second reference aeration hole (h2). The second reference aeration hole (h2) indicates the aeration hole which is closest to the first reference aeration hole (h1) among the second aeration holes 122.

The distance between the first and second reference aeration holes (h1, h2) is adjusted to satisfy the following equation 1.

0.9·2·(H+d)·tan(θ/2)≦D≦1.1·2·(H+d)·tan(θ/2) [Equation 1]

wherein ‘D’ is the distance (m) between the first and second reference aeration holes (h1, h2); ‘H’ is the height (m) of the filtering membrane module 110; ‘d’ is the distance (m) between the first reference aeration hole (h1) and the filtering membrane module 110; and ‘θ’ is the aeration angle.

According to one embodiment of the present invention, the height (H) of the filtering membrane module 110 is 1.8 m; the distance (d) between the first reference aeration hole (h1) and the filtering membrane module 110 is 0.1 m; the aeration angle (θ) is 2.9°; and the distance (D) between the first and second reference aeration holes (h1, h2) is 0.096 m.

The distance between the aeration holes 122 neighboring in the longitudinal direction of the aeration tube 120 may be identical with or smaller than the distance between the first and second reference aeration holes (h1, h2). In this case, since the bubbles generated from the aeration holes 122 neighboring in the longitudinal direction of the aeration tube 120 are overlapped before they attain the uppermost of the filtering membrane module 110, it is possible to perfectly prevent the contamination of filtering membrane. In an aspect of consumed energy, even though the number of aeration hole 122 is increased in an aeration tube 120, the increase of consumed energy is insignificant. Thus, though the distance between the aeration holes 122 neighboring in the longitudinal direction of the aeration tube 120 is identical with or smaller than the distance between the first and second reference aeration holes (h1, h2), there is no meaningful increase of consumed energy.

From the following tests, the present inventor can know that the energy amount consumed for the aeration process considerably relates with a diameter of the aeration hole 121, 122.

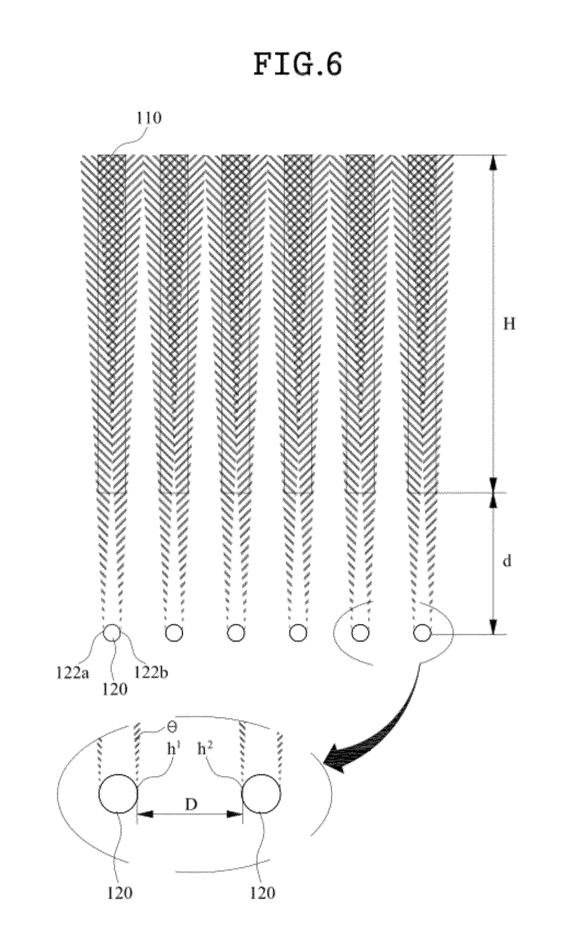

First, there were prepared three kinds of aeration tubes which have the aeration holes whose diameter sizes are respectively 8 mm, 5 mm and 3 mm. The distance between the aeration holes neighboring in the aeration tube was 100 mm identically in each tube. Under the circumstances that all other conditions are maintained identically, the change of consumed energy (Inverter Frequency, Hz) according to the increase of air flux (L/min) jetted from the aeration hole is measured in the respective three kinds of aeration tubes, wherein the measured results are shown in the graph of FIG. 7.

As known from the graph of FIG. 7, while the energy amount required for jetting the same air flux from the aeration hole, for example, jetting the air at 400 L/min is greatly high when the diameter size of aeration hole is 3 mm, the above energy amount is lowest when the diameter size of aeration hole is 8 mm. That is, on the basis of the above results, it is preferable to provide the filtering system having the aeration hole whose diameter is not less than 5 mm in consideration for the amount of energy consumed.

If the diameter of aeration hole is excessively large, horizontal dependence of the aeration tube becomes large so that it is impossible to secure the uniform cleaning for the entire filtering membranes, which will be explained in detail as follows.

As mentioned above, the aeration tube 120 jetting the air for aeration might be not maintained in the initial horizontal state due to the reaction to the jetted air, occasionally. If the horizontal state of the aeration tube 120 is not maintained for the aeration process, the air jetted from the aeration tube is concentratedly supplied to a direction, whereby it is impossible to realize the uniform cleaning for the entire filtering membranes.

From the following tests, it is known that the concentrated supply of air jetted from the aeration tube 120 when the aeration tube is not maintained in the horizontal state, that is, the horizontal dependence of the aeration tube 120 considerably relates with the diameter size of the aeration hole 121, 122.

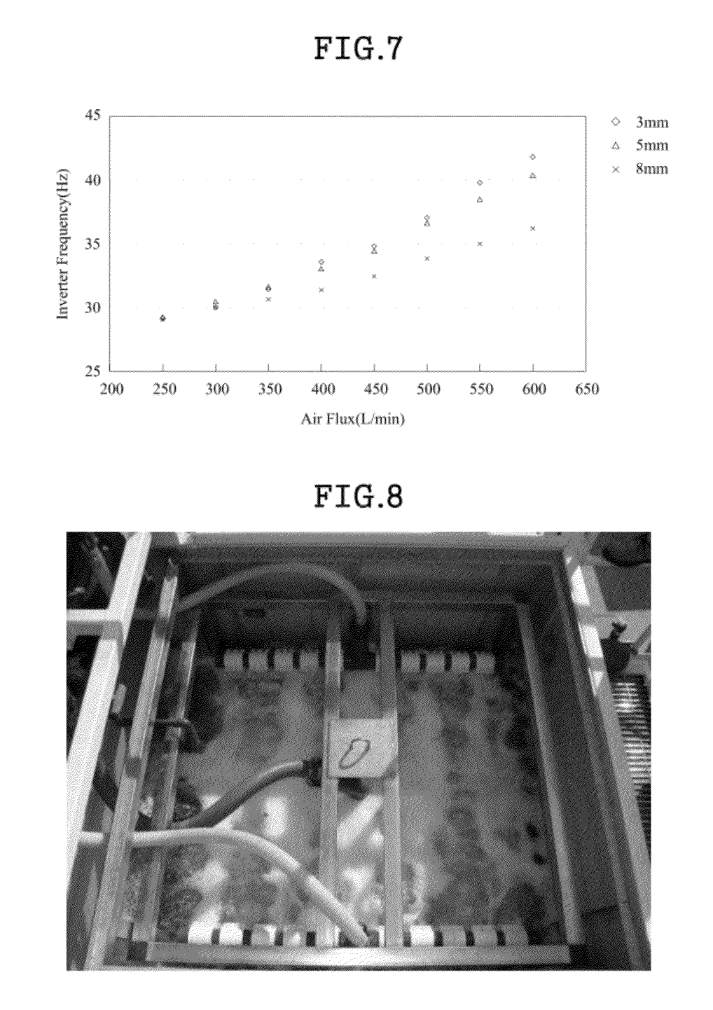

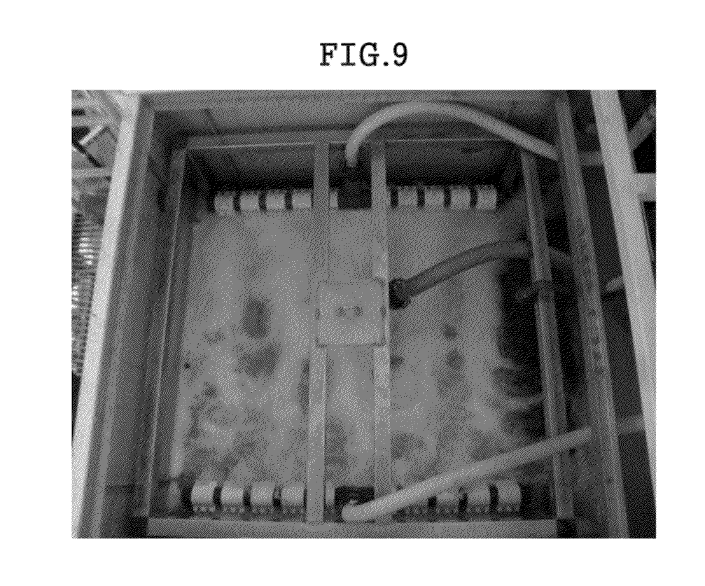

First, there were prepared two kinds of aeration tubes which have the aeration holes whose diameter sizes are respectively 8 mm and 5 mm. The distance between the aeration holes neighboring in the aeration tube was 100 mm identically in each tube. Under the circumstances that all other conditions are maintained identically, the aeration tubes are provided at an about 5° with respect to the bottom surface of the water-treatment tank, and then the air is jetted at 400 L/min. Thereafter, the surface of water is photographed, which is shown in FIGS. 8 and 9.

As known from FIGS. 8 and 9, when the air is jetted under the condition that the aeration tubes having the aeration hole whose diameter is 8 mm is provided at about 5° with respect to the bottom surface of the water-treatment tank, the jetted air is concentratedly supplied toward one direction. Meanwhile, when the air is jetted under the condition that the aeration tubes having the aeration hole whose diameter is 5 mm is provided at about 5° with respect to the bottom surface of the water-treatment tank, the jetted art is uniformly supplied only with little tendency to concentration.

According to the present invention, it is preferable to provide the aeration hole 121, 122 having the diameter of 5 mm to 7 mm so as to reduce the energy amount consumed for jetting the same air flux via the aeration hole 121, 122 and minimize the horizontal dependence of the aeration tube 120.

What is claimed is:

1. A filtering system comprising:
a plurality of filtering membrane modules;
a first aeration tube positioned under the plurality of filtering membrane modules; and
a second aeration tube next to the first aeration tube, the second aeration tube being positioned under the plurality of filtering membrane modules,
wherein the first aeration tube includes a plurality of first aeration holes which include a first reference aeration hole, wherein the first reference aeration hole is closest to the second aeration tube among the first aeration holes,
wherein the second aeration tube includes a plurality of second aeration holes which include a second reference aeration hole, wherein the second reference aeration hole is closest to the first reference aeration hole among the second aeration holes, and
wherein a distance between the first and second reference aeration holes is adjusted to satisfy the following equation 1:
0.9·2·(H+d)·tan(θ/2)≦D≦1.1·2·(H+d)·tan(θ/2) [Equation 1]
wherein ‘D’ is the distance (m) between the first and second reference aeration holes, ‘H’ is a height (m) of the filtering membrane module, ‘d’ is a distance (m) between the first reference aeration hole and the filtering membrane modules, and ‘θ’ is an aeration angle.

2. The filtering system according to claim 1, wherein the filtering membrane modules are hollow fiber membrane modules.

3. The filtering system according to claim 2, wherein the hollow fiber membrane modules are vertical type hollow fiber membrane modules in which a longitudinal direction of a hollow fiber membrane is perpendicular to a bottom surface of a water-treatment tank.

4. The filtering system according to claim 2, wherein the hollow fiber membrane modules are horizontal type hollow fiber membrane modules in which a longitudinal direction of a hollow fiber membrane is parallel to a bottom surface of a water-treatment tank.

5. The filtering system according to claim 1, wherein the filtering membrane modules are flat-type modules.

6. The filtering system according to claim 1, wherein the first and second aeration holes are arranged in line along a longitudinal direction of the first and second aeration tubes respectively.

7. The filtering system according to claim 1, wherein the first aeration holes include a plurality of pairs of first aeration holes, each pair including two of the first aeration holes formed in line perpendicular to a longitudinal direction of the first aeration tube.

8. The filtering system according to claim 1, wherein the second aeration holes include a plurality of pairs of second aeration holes, each pair including two of the second aeration holes formed in line perpendicular to a longitudinal direction of the second aeration tube.

9. The filtering system according to claim 1, wherein a distance between the first aeration holes neighboring in the longitudinal direction of the first aeration tube, and a distance between the second aeration holes neighboring in the longitudinal direction of the second aeration tube are identical with or smaller than the distance between the first and second reference aeration holes.

10. The filtering system according to claim 1, wherein each of the first and second aeration holes has a diameter of 5 mm to 7 mm.

11. A filtering system comprising:
a filtering membrane module; and
first and second aeration tubes next to each other and positioned under the filtering membrane module,
wherein the first aeration tube includes a plurality of first aeration holes arranged in line along a longitudinal direction of the first aeration tube, wherein the plurality of first aeration holes include a first reference aeration hole which is closest to the second aeration tube among the first aeration holes,
wherein the second aeration tube includes a plurality of second aeration holes arranged in line along a longitudinal direction of the second aeration tube, wherein the plurality of second aeration holes include a second reference aeration hole which is closest to the first reference aeration hole among the second aeration holes, and
wherein a distance between the first aeration holes and a distance between the second aeration holes are identical with or smaller than a distance between the first and second reference aeration holes.

12. A filtering system comprising:
a filtering membrane module; and
an aeration tube including a plurality of aeration holes, the aeration tube positioned under the filtering membrane module,
wherein a diameter of the aeration hole is 5 mm to 7 mm.
